(19) United States
(12) Patent Application Publication
(10) Pub. No.: US 2015/0073311 A1
(43) Pub. Date: Mar. 12, 2015

(54) METHOD AND DEVICE FOR TREATING PATHOLOGICAL CONDITIONS ASSOCIATED WITH BONE AND MUSCULOSKELETAL ENVIRONMENTS

(71) Applicant: Moshe Ein-Gal, Ramat Hasharon (IL)

(72) Inventor: Moshe Ein-Gal, Ramat Hasharon (IL)

(21) Appl. No.: 14/020,857

(22) Filed: Sep. 8, 2013

(51) Int. Cl. A61H 23/00

(52) U.S. Cl. CPC A61H 23/008; A61H 2201/0111; A61H 2201/105
USPC 601/2

(57) ABSTRACT

Apparatus includes a treatment bag configured to at least partially encapsulate a body portion to be treated, the treatment bag being generally leak-proof and transparent to acoustic waves and at least partially filled with a shockwave transmission liquid. An acoustic wave device includes a transducer operative to generate acoustic waves. A focusing device focuses the acoustic waves toward a focus. The acoustic wave device is placed near or against the treatment bag and arranged with respect to a target in the body portion, which it is desired to treat, so that the acoustic waves generated by the transducer propagate towards the focus via the shockwave transmission liquid in the bag.

### FIELD OF THE INVENTION

The present invention generally relates to methods and apparatus for medical treatment of pathological conditions by means of acoustic shock waves, and particularly to methods and apparatus for using acoustic shock waves to treat a variety of pathological conditions associated with bone and musculoskeletal environments (including bone, cartilage, ligaments, tendons, fascia, joint capsules, bone marrow and muscle) such as, but not limited to, diabetic foot ulcers, pressure sores, and many others.

### BACKGROUND OF THE INVENTION

Extracorporeal shock wave therapy (ESWT) is the non-surgical treatment of medical conditions using acoustic shock waves. Acoustic shock waves for ESWT may be generated by a variety of methods, such as electrohydraulic, electromagnetic, or piezoelectric.

In the propagation and transmission of waves, energy is lost at interfaces with differing mechanical impedances, for example, water and air. A coupling system is needed to minimize the dissipation of energy of a shockwave as it traverses the skin surface. Water is usually used as propagation liquid, as it has mechanical impedance similar to that of soft tissue. In first-generation lithotriptors, the patient was placed in a water bath such that waves produced by underwater spark-gap discharge were directly coupled to the patient.

In subsequent shockwaves devices, direct water contact with patient's skin has been abandoned. A flexible membrane (typically, silicone or latex) encapsulating the transducer head is coupled to the skin.

The skin-membrane interface should be air-free for adequate wave transmission across the interface. Typically, a significant coupling pressure is applied to the interface by pressing the flexible membrane against the smooth skin, while proper lubrication is applied to the interface. Adequate coupling pressure requires elevated transducer pressure, i.e., pressure on the transducer side of the flexible membrane.

Small number of tiny air bubbles in the interface may not significantly affect wave propagation toward deep-seated targets since the coupling area is relatively large (the wave on the skin is not fully focused). However, acoustic energy delivered to such air bubbles may burst the bubbles and cause skin damage and pain.

Attempting to focus shockwaves on a skin wound or on a target close to the skin may encounter the following difficulties: the skin-membrane interface may not be smooth and free of air-bubbles, the target may be sensitive to pain, pressing a membrane against the skin for obtaining adequate coupling pressure may be painful, even minute air bubbles at the interface may cause additional skin damage and pain since the wave at the interface is already fully focused, and if a water bath approach is used, clean (perhaps sterile)water has to be provide for each patient, especially when the target is infected or inflamed.

For the purpose of this invention, shockwaves are pulsed acoustical waves at a low repetition frequency, whereas the associated wave fronts are not necessarily very steep.

U.S. Pat. No. 7,189,209 describes methods for treating pathological conditions associated with bones and musculoskeletal environments, as well as soft tissue. The method includes applying acoustic shock waves to the site of a pathological condition associated with bone, a musculoskeletal environment, or soft tissue to induce, reactivate, or accelerate the body's natural healing processes. The method includes locating the site of a pathological condition, generating acoustic shock waves, focusing the acoustic shock waves on the pathological site, and applying the focused acoustic shock waves to the site to induce localized trauma or micro-injury and increased vascularization.

### SUMMARY OF THE INVENTION

The present invention seeks to provide improved methods and apparatus for treating pathological conditions associated with bones and musculoskeletal environments, as well as soft tissue, as is described more in detail hereinbelow.

The present invention relates to methods for treating pathological conditions associated with bones and musculoskeletal environments, as well as soft tissue, such as for treating diabetic foot ulcers, pressure sores, cutaneous, subcutaneous, and fascial geographic tissue injuries, defects, or deficits, degenerative joint diseases, soft tissue injuries, decalcification, osteochondromatosis and enchondromatosis, facet osteoarthritis, abnormal neuromuscular pain and abnormalities of development.

There is thus provided in accordance with a non-limiting embodiment of the present invention apparatus including a treatment bag configured to at least partially encapsulate a body portion to be treated, the treatment bag being generally leak-proof and transparent to acoustic waves and at least partially filled with a shockwave transmission liquid an acoustic wave device including a transducer operative to generate acoustic waves, a focusing device for focusing the acoustic waves toward a focus, the acoustic wave device being placed near or against the treatment bag and arranged with respect to a target in the body portion, which it is desired to treat, so that the acoustic waves generated by the transducer propagate towards the focus via the shockwave transmission liquid in the bag.

In accordance with an embodiment of the present invention the treatment bag includes means for controlling the hydrostatic pressure of the shockwave transmission liquid in the treatment bag.

In accordance with an embodiment of the present invention the transducer includes transducer transmission liquid through which the acoustic waves propagate and means for controlling the hydrostatic pressure of the transducer transmission liquid.

In accordance with an embodiment of the present invention the transducer further includes an outer membrane, the outer membrane at least partially enclosing the transmission liquid in the transducer.

In accordance with an embodiment of the present invention the outer membrane of the acoustic wave device is attached to the treatment bag.

In accordance with an embodiment of the present invention the focusing device of the acoustic wave device focuses the acoustic waves onto one of a point, line segment, and a circular segment.

In accordance with an embodiment of the present invention the shockwave transmission liquid in the treatment bag includes a medication.

In accordance with an embodiment of the present invention a thermal unit is placed in or on the treatment bag and connected to and controlled by a temperature controller.

There is also provided in accordance with an embodiment of the present invention a method for treating a body portion including at least partially encapsulating a body portion in a treatment bag at least partially filled with a shockwave transmission liquid, placing an acoustic wave device near or against the treatment bag and arranged with respect to a target in the body portion, which it is desired to treat, and generating and focusing acoustic waves towards a focus via the shockwave transmission liquid in the bag.

### BRIEF DESCRIPTION OF THE DRAWINGS

The present invention will be understood and appreciated more fully from the following detailed description, taken in conjunction with the drawing in which:

FIG. 1 is a simplified illustration of apparatus for treating pathological conditions associated with bones and musculoskeletal environments, in accordance with a non-limiting embodiment of the present invention.

### DETAILED DESCRIPTION OF EMBODIMENTS

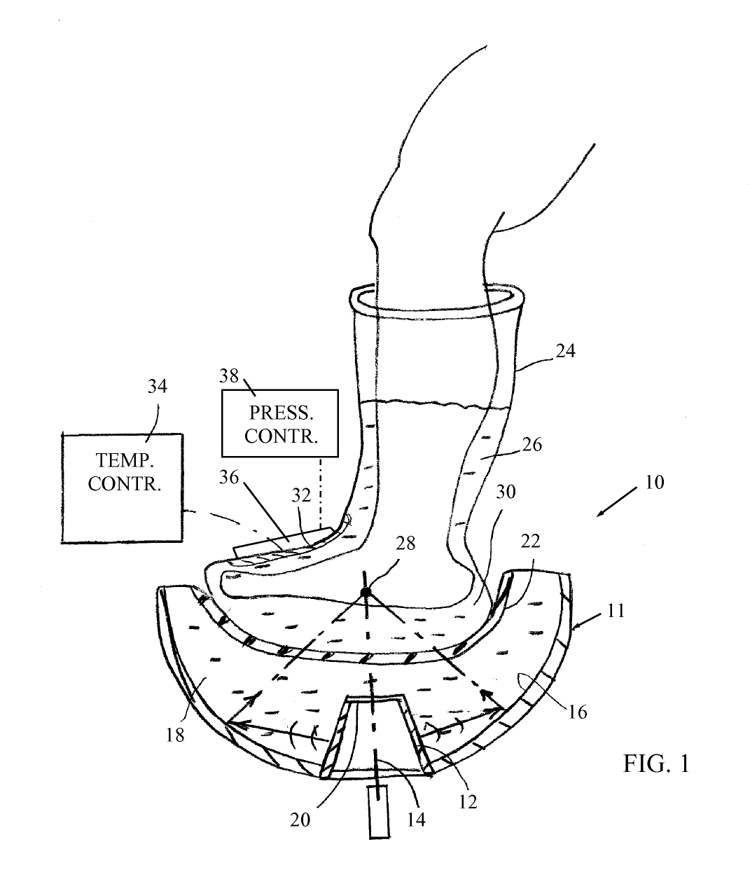

Reference is now made to FIG. 1, which illustrates apparatus 10 for treating pathological conditions associated with hones and musculoskeletal environments, in accordance with a non-limiting embodiment of the present invention.

Apparatus 10 includes an acoustic wave device 11. In the illustrated embodiment, acoustic wave device 11 is similar to that of U.S. Pat. No. 6,869,407 to Ein-Gal, but the invention is not limited to such an acoustic wave device and may be carried out with any other suitable acoustic wave device.

In the illustrated embodiment, acoustic wave device 11 includes an acoustic wave transducer 12 shaped like a cone, most preferably a truncated cone, with an axis of symmetry 14. An at least partially parabolic reflector 16 is arranged with respect to transducer 12 so as to focus an acoustic wave emanating from transducer 12. (Other focusing devices may be used.) It is noted that the present invention is not limited to a cone-shaped acoustic wave device, and may be carried out with other shapes as well, such as but not limited to, cylindrical acoustic wave devices.

The inner volume of reflector 16 may be filled with a transducer transmission liquid 18, and an open end of transducer 12 may be covered with a membrane 20 in order to seal the inside of transducer 12 from ingress therein of transducer transmission liquid 18. The end face of reflector 16 may be covered with an outer membrane 22 that vibrates in accordance with the shock waves (acoustic waves) impinging thereon.

Apparatus 10 also includes a treatment bag 24, which at least partially encapsulates the body portion to be treated, such as, without limitation, a foot (e.g., for treating diabetic foot ulcers or pressure sores). Bag 24 may be made of any suitable material, which is generally leak-proof and transparent to acoustic waves, such as, but not limited to, silicone, latex, plastics and many others. Bag 24 is at least partially filled with a shockwave transmission liquid 26 (such as, without limitation, water).

Acoustic wave device 11 is placed near or against treatment bag 24 and arranged with respect to a target 28, which it is desired to treat, so that acoustic waves generated by transducer 12 propagate towards a focus, located at target 26, via transducer transmission liquid 18, through membrane 22, and via shockwave transmission liquid 26 in bag 24. Accordingly, the encapsulated body portion is placed relative to acoustic wave device 11 such that the acoustic waves propagate through bag 24 and shockwave transmission liquid 26 and reach the target 26 to be treated (e.g., foot ulcer). Preferably, the bag liquid 26 and the transducer transmission liquid 18 allow acoustic waves to propagate with negligible attenuation.

In one embodiment, the outer membrane 22 of acoustic wave device 11 may be positioned and fastened or attached to bag 24.

In the illustrated embodiment, acoustic wave device 11 focuses the acoustic waves onto a point. In other embodiments, the acoustic wave device can focus the acoustic waves onto a line segment, a point or a circle, and others, using different reflectors and transducers.

In one embodiment, shockwave transmission liquid 26 in bag 24 includes medication 30 (e.g., steroids or others) for increased therapeutic activity on the body portion.

In one embodiment, temperature of the bag liquid 26 can be controlled by a thermal unit 32 placed in or on bag 24 and connected to and controlled by a temperature controller 34. Thermal unit 32 may include a heater (e.g., resistive heater) or cooler (e.g., a thermoelectric unit that works with the Peltier effect) and a temperature sensor (e.g., thermistor) to work in a closed-loop control with feedback with controller 34. Controlling the temperature may be used to increase the therapeutic effect.

Additionally or alternatively, pressure of the bag liquid 26 can be controlled by a pressure unit 36 placed in or on bag 24 and connected to and controlled by a pressure controller 38. Pressure unit 36 may include a pump in contact with the liquid in the bag or an areal plate operable to apply external pressure on the bag, wherein the bag is tightly sealed and wherein the plate may be rigid or flexible

The scope of the present invention includes both combinations and subcombinations of the features described hereinabove as well as modifications and variations thereof which would occur to a person of skill in the art upon reading the foregoing description and which are not in the prior art.

1. Apparatus comprising:
a treatment bag configured to at least partially encapsulate a body portion to be treated, said treatment bag being generally leak-proof and transparent to acoustic waves and at least partially filled with a shockwave transmission liquid; and
an acoustic wave device comprising a transducer operative to generate acoustic waves, said acoustic wave device being placed near or against said treatment bag and arranged with respect to a target in the body portion, which it is desired to treat, so that the acoustic waves generated by said transducer propagate towards the target via said shockwave transmission liquid in said bag.

2. The apparatus according to claim 1, wherein said treatment bag comprises a pressure unit for adjusting the hydrostatic pressure of the liquid in the bag.

3. The apparatus according to claim 1, wherein said acoustic wave device comprises a transducer transmission liquid through which the acoustic waves propagate and an outer membrane that is configured to transmit the acoustic waves impinging thereon.

4. The apparatus according to claim 3, wherein said outer membrane of said acoustic wave device is attached to said treatment bag.

5. The apparatus according to claim 3, wherein the acoustic wave device comprises a transducer pressure unit operable to adjust a hydrostatic pressure of the transducer transmission liquid

6. The apparatus according to claim 4, wherein the treatment bag is configured to press against the outer membrane of the transducer.

7. The apparatus according to claim 1, further comprising a focusing device for focusing the acoustic waves to a focus, wherein said focusing device is operative to focus the acoustic waves onto one of a point, line segment, and a circle.

8. The apparatus according to claim 1, wherein said shockwave transmission liquid comprises a medication.

9. The apparatus according to claim 1, further comprising a thermal unit placed in or on said treatment bag and connected to and controlled by a temperature controller.

10. A method for treating a body portion comprising:
at least partially encapsulating a body portion in a treatment bag at least partially filled with a shockwave transmission liquid;
placing an acoustic wave device near or against said treatment bag and arranged with respect to a target in the body portion, which it is desired to treat; and
generating and focusing acoustic waves so as to propagate toward a target in the body portion via said shockwave transmission liquid in said bag.
